(19) United States
(12) Patent Application Publication
(10) Pub. No.: US 2004/0082717 A1
(43) Pub. Date: Apr. 29, 2004

(54) Keratin-silicone copolymers and interpenetrating networks (IPN's), methods of production and methods of use thereof

(75) Inventors: Mark E. Van Dyke, Fair Oaks Ranch, TX (US); Cheryl R. Blanchard, Warsaw, IN (US); Robert A. Smith, Jackson, IN (US)

Correspondence Address: VINSON & ELKINS, L.L.P., 1001 FANNIN STREET, 2300 FIRST CITY TOWER, HOUSTON, TX, 77002-6760, US

(73) Assignees: Southwest Research Institute; Keraplast Technologies, Ltd.

(21) Appl. No.: 10/606,279

(22) Filed: Jun. 24, 2003

Related U.S. Application Data
(60) Provisional application No. 60/390,905, filed on Jun. 24, 2002.

(51) Int. Cl. C08H 1/00

(52) U.S. Cl. 525/54.1; 527/200; 527/201; 525/903

(57) ABSTRACT

Materials comprising proteinaceous prepolymers comprising at least one first reactive group reacted with one or more reactive groups on synthetic prepolymers, and methods of making and using same.

### FIELD OF THE INVENTION

The present invention relates to biomaterials, specifically to bulk copolymer materials comprising a functionalized proteinaceous prepolymer and a functionalized synthetic prepolymer. More particularly,. the invention relates to keratin-silicone bulk copolymer materials, which are rendered biocompatible and biologically active by grafting functionalized protein prepolymers with complimentary functionalized silicone prepolymers. The silicone prepolymers can serve either as a functionalized block in a grafted block copolymer system or as a crosslinking block in an interpenetrating network (IPN) of keratin and silicone.

### BACKGROUND OF THE INVENTION

Modified keratin has been investigated as a biomaterial and as an active component in wound healing products. Unfortunately, keratin sheet and film wound dressings have been difficult to produce, store, and use. A strong need exists for bulk biomaterials and wound dressings that are biocompatible, relatively easy to mass produce, stable on storage, durable and easy to use.

Human hair—particularly the hair of the recipient of a biomedical implant or the hair of a donor—has been suggested as a biocompatible biomaterial for a variety of medical uses. Human hair meets many of the foregoing needs for bulk biomaterials and wound dressings. However, human hair, alone, does not have adequate mechanical properties for many uses. Methods are needed to modify a, proteinaceous material, such as keratin, preferably harvested from the intended recipient of a medical implant, in order to impart desirable mechanical properties to the keratin. Preferably, any such methods would maintain or enhance the bioinertness and wound healing activity of the resulting material.

Silicone would be an equally biocompatible material to alter the mechanical properties of a proteinaceous material, such as keratin Unfortunately, most silicones used in medical applications are nonpolar, inert and highly hydrophobic. Most proteins, on the other hand, are polar, hydrophilic and thermodynamically incompatible with most silicones. Methods are needed to stably bond protein chains to silicone chains to impart desirable mechanical properties to the protein.

### SUMMARY OF THE INVENTION

A material comprising a proteinaceous prepolymer comprising first reactive groups and a synthetic prepolymer comprising second reactive groups, at least a portion of said first reactive groups being reacted with said second reactive groups.

### DETAILED DESCRIPTION OF THE INVENTION

The present invention provides a component of a “medical implant” or a wound dressing comprising functionalized proteinaceous prepolymer and functionalized synthetic prepolymer. In a preferred embodiment, (a) the functionalized proteinaceous prepolymer is compatibilized keratin, and (b) the functionalized synthetic prepolymer is compatibilized silicone.

In this preferred embodiment, the bulk copolymers or IPN's are prepared from keratin prepolymer that has been modified with first functional groups that are reactive toward second functional groups on silicone prepolymers. The silicone prepolymer is grafted onto the modified keratin prepolymer, preferably by directly reacting the complimentary first and second functional groups. IPN's can be formed when the silicone prepolymer is at least difunctional and is used as a crosslinking agent.

As used herein, the phrase “interpenetrating network” or “IPN” has its standard meaning in the art; namely, a combination of two or more dissimilar macromolecules that are substantially compatibilized by the formation of covalent bonds between said dissimilar macromolecules [see Frisch, H. L. and Huang, M. W. in Siloxane Polymers, Clarson, S. J. and Semlyen, J. A. (Editors), PTR Prentice Hall, Inc., New Jersey, pp. 649-667 (1993)), incorporated herein by reference. “Compatibilized” also is intended to have its standard meaning, namely, that the “compatibilized” materials will not substantially phase separate into their respective pure components during preparation or under expected conditions of use. In the case of a medical implant, these conditions would include exposure to body temperature, bodily fluids, and mechanical stresses.

A preferred method for compatibilizing silicone is the use of thiol chemistry to form mercapto functional siloxanes. In this embodiment, thiol chemistry is used to form a chemically and mechanically stable bond between functional groups on the proteinaceous material and the mercapto groups on the siloxanes.

Substantially any biomaterial can serve as a synthetic prepolymer to be suitably functionalized and copolymerized. Suitable compatibilizing functionalities are “reactive groups,” defined as groups which undergo nucleophilic addition, but which do not render the compatibilized synthetic prepolymer unstable. Suitable, reactive groups include, but are not necessarily limited to one or more reactive unsaturated carbon-carbon bonds, ester groups, organic acid groups, amine groups, alkylamino groups having from about 1 to about 3 carbon atoms, hydroxyl groups, hydrido groups, or sulfhydryl groups. Depending upon position, preferred reactive groups are thiol groups and/or vinyl groups, more preferably thiol terminated pendant groups or vinyl terminated pendant groups.

Illustrative synthetic pre polymers suitable for functionalization include but are not necessarily limited to, thermoplastics such as polyesters, polycarbonates, polyolefins, polyethers, polysulfones, urethanes and thermosets, such as polyurethanes, silicones, and epoxies. Preferred synthetic prepolymers for treatment according to the invention are silicones, most preferably silicones prepared from copolymers comprising reactive groups.

Suitable silicones have the following general structure:

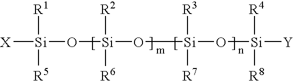

herein

m is from about 5 molar % to about 95 molar %;

n is from about 95 molar % to about 5 molar;

and, X, Y, R¹, R², R³, R⁴, R⁵, R⁶, R⁷, and R⁸ independently are selected from the group consisting of reactive groups, alkyl groups having from about 1 to about 3 carbon atoms, phenyl groups, and perflouro groups having from about 1 to about 3 carbon atoms;

provided that,

at least one of X, Y, R¹, R², R³, R⁴, R⁵, R⁶, R⁷, and R⁸ is a reactive group, most preferably at least one of X, Y, R², R⁶, R³, and R⁷ is a reactive group;

no more than one of X, R¹, and R⁵ is a reactive group;

and, no more than one of Y, R⁴, and R⁸ is a reactive group.

In a preferred embodiment, R¹, R⁴, R⁵, and R⁸ are selected from the group consisting of methyl groups, ethyl groups, and phenyl groups. Preferred alkyl groups for X and Y are methyl groups. Preferred reactive groups for X and Y are vinyl groups. Because thiol groups at the X and/or Y position would be expected to render the silicone molecule unstable, thiol groups are not preferred as reactive groups for the X and Y position. For R², R⁶, R³, and R⁷, preferred reactive groups are selected from the group consisting of reactive vinyl groups and reactive thiol groups, most preferably selected from the group consisting of thiol terminated pendant groups and vinyl terminated pendant groups. Preferred thiol terminated pendant groups are alkyl thiol pendant groups, most preferably n-alkylthiol pendant groups wherein the alkyl has about 1 to about 3 carbon atoms;

Where the material is to form an IPN, at least two of X, Y, R¹, R², R³, R⁴, R⁵, R⁶, R⁷, and R⁸ are reactive groups. Most preferably, at least two of X, Y, R², R⁶, R³, and R⁷ are reactive groups; provided that no more than one of X, R¹, and R⁵ is a reactive group; and no more than one of Y, R⁴, and R⁸ is a reactive group.

Most preferred functionalized silicones are mercapto functional siloxanes, preferably those prepared from copolymers containing n-propylthiol pendant groups. An example of this preferred type of thiol-functional silicone is shown below:

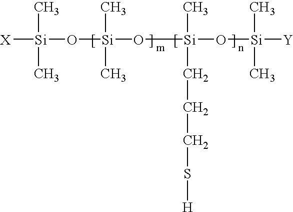

wherein

m is from about 5 molar % to about 95 molar %;

n is from about 95 molar % to about 5 molar %; and

X and Y independently are selected from the group consisting of methyl groups, hydroxyl groups, and a combination thereof.

Another preferred functionalized silicone comprises vinyl functional siloxanes, preferably those prepared from copolymers containing vinyl pendant groups. Examples of these preferred type of vinyl-functional siloxanes are shown below:

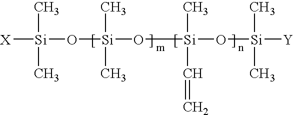

wherein

m is from about 5 molar % to about 95 molar %;

n is from about 95 molar % to about 5 molar %; and,

X and Y independently are selected from the group consisting of methyl groups, hydroxyl groups, and a combination thereof.

Another preferred vinyl functional silicone comprises terminal vinyl groups. Examples of these preferred type of vinyl-functional silicones are shown below:

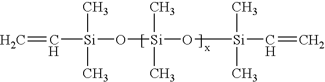

wherein x is from about 1 to about 3000.

Examples of suitable proteinaceous prepolymers for functionalization according to the invention include, but are not necessarily limited to keratin, collagen, fibrin and other growth factors. A preferred proteinaceous prepolymer is keratin derived from human hair or nails. A most preferred proteinaceous prepolymer is keratin derived from hair which is harvested from the intended recipient of a medical implant or wound dressing to be used in treating said recipient.

The keratin also may be derived from hair from a person other than the recipient Other sources of keratin include but are not necessarily limited to animal hair, skin, hooves, horns, beaks, feet and feathers.

In a preferred embodiment, hair harvested from the intended recipient is processed into keratin prepolymer using any known means. A preferred means is reduction using a suitable reagent. Suitable reagents include, but are not necessarily limited to, sulfides such as sodium sulfide and sodium hydrogen sulfide, thioglycolate, cyanide, urea, sulfites such as sodium sulfite and sodium bisulfite, mercaptoethanol 1and combinations thereof. Preferred reagents have a pH of from about 7 to about 12. Most preferred reagents are thioglycolate, urea and mercaptoethanol, typically used in combination with a basic material to maintain the desired pH. Preferred bases are easily removed by washing or volatilization. A most preferred base is ammonium hydroxide. [for details see: Anson, M. L., Bailey, K. and Edsall, J. T. (Editors), Advances in Protein Chemistry, Academic Press Inc., New York (1954) and Yarnauchi, K., Yamauchi, A., Kusunoki, T., Kohda, A. and Konishi, Y., “Preparation of Stable Aqueous Solution of Keratins, and Physiochemical and Biodegradational Properties of Films”, J. Biomed. Mat. Research 31, pp. 439-444 (1996), herein incorporated in their entirety by reference].

The terminal sulfur in the mercapto functionality pendant to the siloxane prepolymer may be directly bonded to an available sulfur atom on the reduced keratin prepolymer using oxidative coupling techniques. The oxidative coupling reaction is carried out by drying a mixture of the two prepolymers in an oxygen-containing atmosphere at temperatures of from about 20° C. to about 70° C. and pressures of from about 0.5 mm Hg to 760 mm Hg. Drying time will vary depending on the thickness of the bulk material. Alternatively, oxidative coupling may be effected with the additional of an oxidizing agent. Preferred oxidizing agents include but are not limited to peracetic acid, hydrogen peroxide, perborates, percarbonates, and ammonium sulfate peroxide. A most preferred oxidizing agent is benzoyl peroxide.

Alternately, the reduced keratin may be bonded to the mercapto functionalized silicone using a suitable multifunctional crosslinking agent, preferably a difunctional crosslinker. Suitable crosslinkers comprise at least two reactive groups which undergo nucleophilic addition. Such reactive groups already have been described. Preferred reactive groups for crosslinkers include, but are not necessarily limited to amine groups, hydroxyl groups or acid groups. Preferred difunctional crosslinkers include but are not necessarily, limited to ethylene glycol, propylene glycol, and glutaraldehyde.

Using a multifunctional crosslinking agent, preferably a difunctional crosslinker, the crosslinker is added to the reduced keratin-silicone mixture and dried at temperatures of from about 20° C. to about 70° C., and pressures of from about 0.5 mm Hg to 760 mm Hg. Care must be taken to use a temperature and pressure which does not volatilize the crosslinker. Drying time will vary depending on the thickness of the bulk material.

In the case of the silicone functionalized by vinyl groups, the thiol group of the reduced keratin may be reacted with the vinyl group of the silicone using Michael Addition chemistry. This type of chemistry can be performed using a variety of catalysts which are well known to those skilled in the art. Examples of “Michael Addition” chemistry can be found in A. Michael, J. Prakt. Chem [2] 35, 349 (1887); R. Connor and W. R. McClelland, J. Org. Chem., 3, 570 (1938); and C. R. Hauser, M. T. Tetenbaum, J. Org. Chem., 23, 1146 (1959), all of which are incorporated by reference herein.

Once the functional groups in the proteinaceous prepolymer have been reacted with the functional groups of the functionalized silicone, the copolymer or IPN is substantially biocompatible, compatibilized, and has “durability and adhesion.” As used herein, the phrase “durability and adhesion” is defined to mean that such that the reacted prepolymers will not separate under simulated use conditions, such as mechanical wear testing.

Testing suitable for assessing durability and adhesion include but are not necessarily limited to ASTM standard F 732 (friction/wear testing for polymeric materials used in total joint prostheses) or D 3359 (peel resistance of lap joints in tension), both of which are incorporated by reference herein. Suitable values will depend on the application. Wear rates should be as good as a similar material or as good as typical polydimethylsiloxane (PDMS) silicone elastomers. A suitable material will have a D3359 score of about 2A, preferably from about 4A to about 5A.

The bulk copolymer material is useful as a wound dressing or to make “medical implants.” As used herein, the phrase “medical implants” is used in a broad sense, and includes, but is not necessarily limited to orbital floor implants; contact lenses; hydrocephalus shunts; chin implants; tracheostomy vents; tracheal stents; breast prostheses; heart valves; finger joints; pacemaker leads; intra-aortic balloon pumps; ureteral stents; oviductal plugs; testicular prostheses; penile prostheses; tibial cups; toe joints; vaginal stents; urethral cuffs; hip implants; knee implants; gluteal pads; antireflux cuffs; artificial skin; extracorporeal blood oxygenators; wrist joints; ear frames; eustachian tubes; maxillofacial implants; and catheters.

Many modifications and variations may be made to the embodiments described herein without departing from the spirit of the present invention. The embodiments described herein are illustrative only should not be construed as limiting the scope of the present invention.

We claim:

1. A material comprising a proteinaceous prepolymer comprising first reactive groups and a synthetic prepolymer comprising second reactive groups, at least a portion of said first reactive groups being reacted with said second reactive groups.

2. The material of claim 1 selected from the group consisting of a compatibilized copolymer and a compatibilized interpenetrating network.

3. The material of claim 2 wherein said portion is effective to provide said material with durability and adhesion.

4. The material of claim 3 wherein said portion comprises first reactive groups covalently bonded to said second reactive groups.

5. A material comprising keratin comprising first reactive groups and a synthetic prepolymer comprising second reactive groups, at least a portion of said first reactive groups being reacted with said second reactive groups.

6. The material of claim 2 wherein said proteinaceous prepolymer comprises keratin.

7. The material of claim 3 wherein said proteinaceous prepolymer comprises keratin.

8. The material of claim 4 wherein said proteinaceous prepolymer comprises keratin.

9. The material of claim 5 wherein said keratin is derived from hair.

10. The material of claim 6 wherein said keratin is derived from hair.

11. The material of claim 7 wherein said keratin is derived from hair.

12. The material of claim 8 wherein said keratin is derived from hair.

13. The material of claim 9 wherein said hair is human hair.

14. The material of claim 10 wherein said hair is human hair.

15. The material of claim 10 wherein said hair is human hair.

16. The material of claim 12, wherein said hair is human hair.

17. The material of claim 5 wherein said keratin is derived from a source selected from the group consisting of skin, beaks, feet, horns, hooves or feathers.

18. A material comprising a proteinaceous prepolymer comprising first reactive groups and at least one silicone comprising second reactive groups, at least a portion of said first reactive groups being reacted with to said second reactive groups.

19. The material of claim 2 wherein said synthetic prepolymer is at least one silicone.

20. The material of claim 3 wherein said synthetic prepolymer is at least one silicone.

21. The material of claim 4 wherein said synthetic prepolymer is at least one silicone.

22. A material comprising keratin comprising first reactive groups and at least one silicone comprising second reactive groups, at least a portion of said first reactive groups being, reacted with said second reactive groups.

23. The material of claim 6 wherein said synthetic prepolymer is at least one silicone.

24. The material of claim 7 wherein said synthetic prepolymer is a silicone.

25. The material of claim 8 wherein said synthetic prepolymer is at least one silicone.

26. The material of claim 9 wherein said synthetic prepolymer is at least one silicone.

27. The material of claim 10 wherein said synthetic prepolymer is at least one silicone.

28. The material of claim 11 wherein said synthetic prepolymer is at least one silicone.

29. The material of claim 12 wherein said synthetic prepolymer is at least one silicone.

30. The material of claim 13 wherein said synthetic prepolymer is at least one silicone.

31. The material of claim 14 wherein said synthetic prepolymer is at least one silicone.

32. The material of claim 15 wherein said synthetic prepolymer is at least one. silicone.

33. The material of claim 16 wherein said synthetic prepolymer is at least one silicone.

34. The material of claim 1 wherein said functionalized synthetic prepolymer is selected from the group comprising thermoplastics and thermosets.

35. The material of claim 34 wherein said thermoplastics are selected from the group consisting of polyesters, polycarbonates, polyolefins, polyethers, polysulfones, and urethanes.

36. The material of claim 2 wherein said functionalized synthetic prepolymer is selected from the group comprising thermoplastics and thermosets.

37. The material of claim 36 wherein said thermoplastics are selected from the group consisting of polyesters, polycarbonates, polyolefins, polysulfones, and urethanes.

38. The material of claim 3 wherein said functionalized synthetic prepolymer is selected from the group comprising thermoplastics and thermosets.

39. The material of claim 38 wherein said thermoplastics ate selected from the group consisting of polyesters, polycarbonates, polyolefins, polyethers, polysulfones, and urethanes.

40. The material of claim 5 wherein said functionalized synthetic prepolymer is selected from the group comprising thermoplastics and thermosets.

41. The material of claim 40 wherein said thermoplastics are selected from the group consisting of polyesters, polycarbonates, polyolefins, polyethers, polysulfones, and urethanes.

42. The material of claim 18 wherein said silicone is a mercapto-functional silicone.

43. The material of claim 22 wherein said silicone is a mercapto-functional silicone.

44. The material of claim 18 wherein said silicone is a vinyl-functional silicone.

45. The material of claim 22 wherein said silicone is a vinyl-functional silicone.

46. The material of claim 18 wherein said silicone has the following general structure: 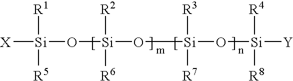
wherein
m is from about 5 molar % to about 95 molar %;
n is from about 95 molar % to about 5 molar %; and,
X, Y, R¹, R², R³, R⁴, R⁵, R⁶, R⁷and R⁸ independently are selected from the group consisting of reactive groups, alkyl groups having from about 1 to about 3 carbon atoms, phenyl groups, and perflouro groups having from about 1 to about 3 carbon atoms;
provided that,
at least one of X, Y, R¹, R², R³, R⁴, R⁵, R⁶, R⁷, and R⁸ is a reactive group, most preferably at least one of X, Y, R², R⁶, R³ and R⁷ are reactive groups;
no more than one of X, R¹, and R⁵ is a reactive group;
and, no more than; one of Y, R⁴, and R⁸ is a reactive group.

47. The material of claim 46 wherein R¹, R⁴, R⁵, and R⁸ independently are selected from the group consisting of methyl groups, ethyl groups, and phenyl groups.

48. The material of claim 46 wherein X and Y are selected from the group consisting of methyl groups and vinyl groups.

49. The material of claim 47 wherein X and Y are selected from the group consisting of methyl groups and vinyl groups.

50. The material of claim 46 wherein at least one of X, Y, R², R⁶, R³, and R⁷ is selected from the group consisting of a reactive vinyl group and a reactive thiol group.

51. The material of claim 46 wherein R², R⁶, R³, and R⁷ comprise reactive groups selected from the group consisting of reactive vinyl groups and reactive thiol groups.

52. The material of claim 46 wherein at least one of R², R⁶, R³, and R⁷ is selected from the group consisting of a thiol terminated pendant group and a vinyl terminated pendant group.

53. The material of claim 52 wherein at least one of R², R⁶, R³, and R⁷ is selected from the group consisting of an n-alkylthiol pendant group comprising an alkyl group having from about 1 to about 3 carbon atoms.

54. The material of claim 47 wherein at least one of R², R⁶, R³, and R⁷ is selected from the group consisting of a thiol terminated pendant group and a vinyl terminated pendant group.

55. The material of claim 54 wherein at least one of R², R⁶, R³, and R⁷ is selected from the group consisting of an n-alkylthiol pendant group comprising an alkyl group having from about 1 to about 3 carbon atoms.

56. The material of claim 48 wherein at least one of R², R⁶, R³, and R⁷ is selected from the group consisting of a thiol terminated pendant group and a vinyl terminated pendant group.

57. The material of claim 56 wherein at least one of R², R⁶, R³, and R⁷ is selected from the group consisting of an n-alkylthiol pendant group comprising an alkyl group having from about 1 to about 3 carbon atoms.

58. The material of claim 49 wherein at least one of R², R⁶, R³, and R⁷ is selected from the group consisting of a thiol terminated pendant group and a vinyl terminated pendant group.

59. The material of claim 58 wherein at least one of R², R⁶, R³, and R⁷ is selected from the group consisting of an n-alkylthiol pendant group comprising an alkyl group having from about 1 to about 3 carbon atoms.

60. The material of claim 50 wherein at least one of R², R⁶, R³, and R⁷ is selected from the group consisting of a thiol terminated pendant group and a vinyl terminated pendant group.

61. The material of claim 60 wherein at least one of R², R⁶, R³, and R⁷ is selected from the group consisting of an n-alkylthiol pendant group comprising an alkyl group having from about 1 to about 3 carbon atoms.

62. The material of claim 51 wherein at least one of R², R⁶, R³, and R⁷ is selected from the group consisting of a thiol terminated pendant group and a vinyl terminated pendant group.

63. The material of claim 62 wherein at least one of R², R⁶, R³, and R⁷ is selected from the group consisting of an n-alkylthiol pendant group comprising an alkyl group having from about 1 to about 3 carbon atoms.

64. The material of claim 18 wherein said silicone has the following general structure: 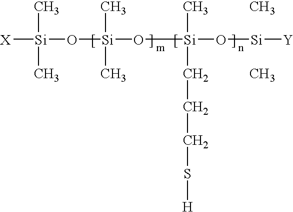
wherein
m is from about 5 molar to about 95 molar %;
n is from about 95 molar % to about 5 molar %; and,
X and Y independently are selected from the group consisting of methyl groups, hydroxyl groups, and combinations thereof.

65. The material of claim 22 wherein said silicone has the following general structure: 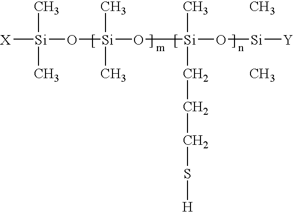
wherein
m is from about 5 molar % to about 95 molar %;
n is from about 95 molar % to about 5 molar %;
and, X and Y independently are selected from the group consisting of methyl groups, hydroxyl groups, and combinations thereof.

66. The material of claim 18 wherein said silicone has the following general structure: 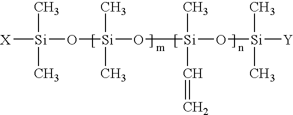
wherein
m is from about 5 molar % to about 95 molar %;
n is from about 95 molar % to about 5 molar %; and,
X and Y independently are selected from the group consisting of methyl groups, hydroxyl groups, and combinations thereof.

67. The material of claim 22 wherein said silicone has the following general structure: 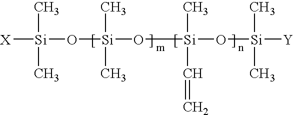
wherein
m is from about 5 molar % to about 95 molar %;
n is from about 95 molar % to about 5 molar %; and,
X and Y independent are selected from the group consisting of methyl groups, hydroxyl groups, and a combination thereof.

68. The material of claim 18 wherein said silicone has the following general structure: 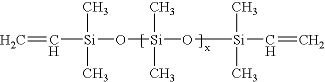
wherein x is from about 1 to about 3000.

69. The material of claim 22 wherein said silicone has the following general structure: 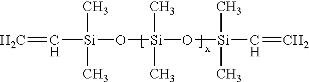
wherein x is from about 1 to about 3000.

70. A medical implant comprising the material of claim 1.

71. A medical implant comprising the material of claim 5.

72. A medical implant comprising the material of claim 18.

73. A medical implant comprising the material of claim 22.

74. A medical implant comprising the material of claim 46.

75. A wound dressing comprising the material of claim 1.

76. A wound dressing comprising the material of claim 5.

77. A wound dressing comprising the material of claim 18.

78. A wound dressing comprising the material of claim 22.

79. A wound dressing comprising the material of claim 46.

80. The medical implant of claim 70 selected from the group consisting of orbital floor implants; contact tenses; hydrocephalus shunts; chin implants; tracheostomy vents; tracheal stems; breast prostheses; heart valves; finger joints; pacemaker leads; intra-aortic balloon pumps; ureteral stems; oviductal plugs; testicular prostheses; penile prostheses; tibial cups; toe joints; vaginal stems; urethral cuffs; hip implants; knee implants; gluteal pads; antireflux cuffs; artificial skin; extracorporeal blood oxygenators; wrist joints; ear frames; eustachian tubes; maxillofacial implants; and catheters.

81. The medical implant of claim 71 selected from the group consisting of orbital floor implants; contact lenses; hydrocephalus shunts; chin implants; tracheostomy vents; tracheal stems; breast prostheses; heart valves; finger joints; pacemaker leads; intra-aortic balloon pumps; ureteral stems; oviductal plugs; testicular prostheses; penile prostheses; tibial cups; toe joints; vaginal stems; urethral cuffs; hip implants; knee implants; gluteal pads; antireflux cuffs; artificial skin; extracorporeal blood oxygenators; wrist joints; ear frames; eustachian tubes; maxillofacial implants; and catheters.

82. The medical implant of claim 72 selected from the group consisting of orbital floor implants; contact lenses; hydrocephalus shunts; chin implants; tracheostomy vents; tracheal stems; breast prostheses; heart valves, finger joints; pacemaker leads; intra-aortic balloon pumps; ureteral stems; oviductal plugs; testicular prostheses; penile prostheses; tibial cups; toe joints; vaginal stems; urethral cuffs; hip implants; knee implants; gluteal pads; antireflux cuffs; artificial skin; extracorporeal blood oxygenators; wrist joints; ear frames; eustachian tubes; maxillofacial implants; and catheters.

83. The medical implant of claim 73 selected from the group consisting of orbital floor implants; contact lenses; hydrocephalus shunts; chin implants; tracheostomy vents; tracheal stems; breast prostheses; heart valves; finger joints; pacemaker leads; infra-aortic balloon pumps; ureteral stems; oviductal plugs; testicular prostheses; penile prostheses; tibial cups; toe joints; vaginal stems; urethral cuffs; hip implants; knee implants; gluteal pads; antireflux cuffs; artificial skin; extracorporeal blood oxygenators; wrist joints; ear frames; eustachian tubes; maxillofacial implants; and catheters.

84. The medical implant of claim 74 selected from the group consisting of orbital floor implants; contact lenses; hydrocephalus shunts; chin implants; tracheostomy vents; tracheal stems; breast prostheses; heart valves finger joints; pacemaker leads; infra-aortic balloon pumps; ureteral stems; oviductal plugs; testicular prostheses; penile prostheses; tibial cups; toe joints; vaginal stems; urethral cuffs; hip implants; knee implants; gluteal pads; antireflux cuffs; artificial skin; extracorporeal blood oxygenators; wrist joints; ear frames; eustachian tubes; maxillofacial implants; and catheters.

85. The material of claim 1 wherein said proteinaceous prepolymer is selected from the group consisting of collagen, fibrin, and a growth factor.

86. The material of claim 18 wherein said proteinaceous prepolymer is selected from the group consisting of collagen, fibrin, and a growth factor.

87. The material of claim 22 wherein said proteinaceous prepolymer is selected from the group consisting of collagen, fibrin, and a growth factor.

88. The material of claim 46 wherein said proteinaceous prepolymer is selected from the group consisting of collagen, fibrin, and a growth factor.

89. A method comprising: providing proteinaceous prepolymers comprising at least one first reactive group; providing synthetic prepolymers comprising at least one second reactive group; and reacting said first and said second reactive groups.

90. The method of claim 89 wherein said proteinaceous prepolymer comprises keratin.

91. The method of claim 89 wherein said synthetic prepolymer is at least one silicone.

92. The method of claim 90 wherein said synthetic prepolymer is at least one silicone.
